(19) United States
(12) Patent Application Publication
(10) Pub. No.: US 2025/0151716 A1
(43) Pub. Date: May 15, 2025

(54) SEED COATING

(71) Applicants: Wasware Ltd c/o Watermill Accounting Ltd, Cambridge, Cambridgeshire (GB); Mana Biosystems Limited, London (GB)

(72) Inventor: Xiaobin Zhao, Cambridge, Cambridgeshire (GB)

(21) Appl. No.: 18/838,293

(22) PCT Filed: Feb. 14, 2023
(86) PCT No.: PCT/GB2023/050333

§ 371 Date: Aug. 14, 2024

(30) Foreign Application Priority Data
Feb. 14, 2022 (GB) 2201898.0

(51) Int. Cl. A01N 25/00; A01N 43/16; A01N 63/14; A01P 17/00; A01P 21/00

(52) U.S. Cl. CPC A01N 25/00; A01N 43/16; A01N 63/14; A01P 17/00; A01P 21/00

(57) ABSTRACT

The invention describes a coated seed comprising: a seed and a coating on the seed wherein the coating comprises a bioadhesive and one or more bioactive agents; wherein the bioadhesive comprises one or more protein-containing biomaterials, an inorganic filler, and a defoamer; and wherein the one or more bioactive agents are selected from a biorepellent, a pesticide, a fertilizer, or a bactericide. The bioactive agent as used in the invention may be frass. The invention also describes a resin comprising a bioadhesive and one or more bioactive agents and a kit comprising a bioadhesive and one or more bioactive agents which can be used in seed coating.

### CROSS-REFERENCE TO RELATED APPLICATIONS

This application is a 371 National Phase Entry of International Patent Application No. PCT/GB2023/050333 filed on Feb. 14, 2023, which claims the benefit of British Patent Application No. 2201898.0 filed on Feb. 14, 2022, the contents of which are incorporated herein by reference in their entirety.

### FIELD OF THE INVENTION

The present invention relates to a coated seed, processes for coating a seed, and to a resin and a kit which can be used in seed coating.

### BACKGROUND OF THE INVENTION

Agriculture is a vital component of many economies. For example, within the UK, the production of the single crop, oil seed rape, generates annually around 700-800 million GBP. Unfortunately, agricultural crops are also vulnerable to damage by pests. In the case of oil seed rape, one particular pest, the cabbage stem flea beetle, can account for 5% to 15% of the crop being lost annually, equivalent to a financial loss of around 70 million GBP.

The agricultural industry also faces problems due to food surplus and waste. Currently, in the UK market it is estimated that food surplus and waste is at 3.6 million metric tons per year, 7.2% of all food harvested, which would have a market value of 1.2 billion GBP. A vast amount of this waste ends up in landfill sites. There is large consensus amongst the UK food retail market that there is a need for novel ways of reducing organic waste.

There are a number of different bio-based repellents and fertilizers which may provide a solution to these issues. One example of such a material is frass. Frass is known as a natural biorepellent. It also has the capability of fertilizing plants and boosting growth due to being rich in nutritional components, for example, carbon, nitrogen, phosphorus, and potassium. Frass is a completely natural product that is generated as a by-product of insect farming and can be generated from insects fed on food waste, thus making the production of frass a cyclic, zero-waste process, that can utilize excess organic waste that has been generated elsewhere.

Currently frass is used as a fertilizer by sprinkling the frass evenly over soil then watering; spreading dry frass with a fertilizer spreader; or mixing frass with soil. These methods can improve growth and reduce damage by pests.

However, as with any biorepellent or fertilizer, large volumes of frass are needed to ensure such methods are effective, with one or two teaspoonfuls per plant or flower typically being used. Additionally, it has been found that any pest larvae which were already inside the crop are still able to do significant damage.

There is a real need in the agricultural industry to find an alternative method that addresses the problems above.

### SUMMARY OF THE INVENTION

The present inventors have developed a coated seed comprising a seed, and a coating on said seed, wherein said coating comprises a bioadhesive and one or more bioactive agents; wherein the bioadhesive comprises one or more protein containing biomaterials, an inorganic filler, and a defoamer; and the one or more bioactive agents are selected from a biorepellent, pesticide, fertilizer, or bactericide.

Using a bioactive agent in this way ensures that the amount of bioactive agent necessary for a seed coating is significantly less than the amount which would be necessary if administered to the soil as in the state of the art. Thus, the invention enables an expansion of the use of fertilizers, such as frass, without the need for significant expansion in their production. The bioactive agent as used herein is also evenly applied to all seeds and is better able to protect each and every plant in a crop, compared with a more random distribution of the agent to soil.

Additionally, when a bioactive agent which is a biorepellent or pesticide is applied as part of a seed coating it is able to protect the seed from pest larvae growing inside the seed, and pests attacking from the outside, and may reduce the vulnerability of the plant to disease. Protection is provided from before the seed is even planted. Therefore, the protection is more complete than the protection provided by biorepellents, such as frass, as used in the state of the art, which is less targeted. When frass is the bioactive agent used in the invention, it may also be absorbed into the seed, which further increases its repellent and fertilizing activity.

The bioadhesive, as used in the invention, has the advantage over the prior art of being biodegradable. Traditionally, adhesives used in seed coatings use synthetic polymer films, the use of which can result in accumulation of nonbiodegradable waste in soil, eventually reducing soil quality.

Additionally, the bioadhesive as described herein can be produced from waste products, such a brewer's spent grain, or distiller's grain. Developing alternative uses for these waste products can prevent the buildup of food waste in landfill sites.

The present invention also provides a process for producing a coated seed comprising applying to a seed (a) one or more bioactive agents as described herein, and (b) a bioadhesive as described herein, and forming a coating on the seed. This process produces a coated seed which has all the advantages of the invention. This process can be performed on a large number of seeds simultaneously prior to planting, therefore increasing the efficiency of the fertilizing methods compared to the state of the art, wherein the bioactive agent must be distributed across a whole area in which plants are growing.

The present invention also provides a coating resin, comprising one or more bioactive agents as described herein and a bioadhesive as described herein. This resin can be applied to seeds to give the same advantages as the coated seed of the invention. Also provided is a kit comprising separately one or more bioactive agents as described herein and a bioadhesive as described herein.

### BRIEF DESCRIPTION OF THE FIGURES

FIG. 1 is the Fourier-transform infrared spectroscopy (FTIR) spectrum of the frass as used in Example 1. The spectrum shows peaks at 1,659 cm⁻¹ and 1,380 cm⁻¹ which are characteristic of the amide (CO—NH) and C—N bond of chitin.

FIGS. 2A-2D are bar chart representations comparing the average root sizes of coated and uncoated Brassica seeds (Caraflex F1, Famosa F1, Covina F1, and Redbor F1, respectively) after one month's growth, as described in Example 4 and Table 2.

FIG. 3 shows the % damage score of coated and uncoated Aurelia OSR seedlings after 14 days (two-sample one-tailed t-test, p=0.03542).

FIG. 4 shows the % damage score of coated and uncoated Aurelia OSR seedlings after 12 days (two-sample one-tailed t-test, p=0.05522).

FIG. 5 shows the root lengths of coated and uncoated Aurelia OSR seedlings after 26 days (two-sample one-tailed t-test, p=0.04453).

FIG. 6 shows the cotyledon diameters of coated and uncoated Aurelia OSR seedlings after 26 days (two-sample one-tailed t-test, p=0.04453).

FIG. 7 shows the % damage score of coated and uncoated Acacia OSR seedlings, with different frasscoat weight ratios, after 24 days (ANOVA test, F=0.136).

FIG. 8 shows the cotyledon diameters of coated and uncoated Acacia OSR seedlings, with different frasscoat ratios after 15 days.

FIG. 9 shows the % damage score of coated and uncoated Nikita OSR seedlings after 17 days (two-sample one-tailed t-test, p=0.184).

FIG. 10 shows the root lengths of coated and uncoated DK Exception OSR seeds after 20 days (two-sample one-tailed t-test, p=0.7697).

FIG. 11 shows the cotyledon diameters of coated and uncoated DK Exception OSR seedlings after 20 days (two-sample one-tailed t-test, p=01745).

FIG. 12 shows % damage score of coated and uncoated Campus OSR seedlings after 26 days (two-sample one-tailed t-test, p=0.000532).

FIG. 13 shows the root lengths of coated and uncoated Campus OSR seedlings after 34 days (two-sample one-tailed t-test, p=0.9985).

FIG. 14 shows the hole diameter of coated and uncoated Campus OSR seedlings after 34 days (two-sample one-tailed t-test, p=0.4005).

FIG. 15 shows % damage score of coated and uncoated DK Exception OSR seedlings after 12 days (two-sample one-tailed t-test, p=0.5614).

FIG. 16 shows % damage score of coated and uncoated DK Exception OSR seedlings after 26 days (two-sample one-tailed t-test, p=0.08184).

FIG. 17 shows the root lengths of coated and uncoated DK Exception OSR seedlings after 48 days (two-sample one-tailed t-test, p=0.9985).

FIG. 18 shows the hole diameter of coated and uncoated DK Exception OSR seedlings after 48 days (two-sample one-tailed t-test, p=0.02288).

FIG. 19 shows % damage score of coated and uncoated Aurelia OSR seedlings, with different seed to coat weight rations, after 24 days (three-sample Kruskal-Wallis rank sum test, p=0.93 [UC-C1], p=0.12 [UC-C2], p=0.12 [C1-C2]).

FIG. 20 shows the root lengths of coated and uncoated Aurelia OSR seedlings, with different seed to coat weight ratios, after 31 days (three-sample one-tailed Kruskal-Wallis rank sum test, p=0.93 [UC-C1], p=0.19 [UC-C2], p=0.19 [C1-C2]).

FIG. 21 shows the hole diameter of coated and uncoated Aurelia OSR seedlings, with different seed to coat weight ratios, after 31 days (three-sample one-tailed Kruskal-Wallis rank sum test, p=0.044 [UC-C1],p=0.208 [UC-C2], p=0.503 [C1-C2]).

### DETAILED DESCRIPTION OF THE INVENTION

### Seeds

The coated seed of the invention may be any type of seed, for example, seeds to grow flowers, fruits, nuts, cereals, herbs, trees, shrubs, and vegetables, for example, legumes, Brassicas, and root vegetables. Typically, the seed is a flower, fruit, or vegetable seed.

Preferably the seed is a Brassica seed. The coated seed as described herein has been shown especially to be effective in improving the root growth, and total biomass gain of Brassica seeds within the first month from planting. Examples of suitable Brassica seeds include mustard, rocket, cabbage, broccoli, and kale, for example, cabbage, broccoli, and kale. More preferably the seed is selected from Caraflex cabbage, Famosa cabbage, Covina broccoli, Redbor kale, and oil seed rape (OSR).

Most preferably the seed is an oil seed rape seed. Oil seed rape is a vitally important crop in terms of protection from pests, as it is frequently used as a rotation crop used to refresh soil and keeping numbers of pests of other crops down. Thus, if farmers are forced to abandon oil seed rape, it can have knock-on effects, reducing the potential yield of other crops, for example, wheat, in subsequent years. Therefore, a fertilizer and/or biorepellent that is efficient in improving growth and/or protecting oil seed rape, also has much wider beneficial effects for agriculture as a whole. OSR comes in many varieties. Typically, when the seed is OSR, the seed is selected from varieties include Aurelia, Acacia, DK Exception, Nikita, and Campus.

The coated seed of the invention, wherein the bioactive agent is frass, has particular efficacy in repelling the cabbage stem fly beetle. The cabbage stem fly beetle is estimated to account for around 5% to 15% of oil seed rape crop being lost annually. Therefore, the efficient repelling of the cabbage stem flea beetle makes the invention particularly beneficial for the growth of oil seed rape.

In some embodiments, the seeds of the invention may be provided as a plurality of seeds as described herein. For example, a plurality of seeds may be provided in a container or package. In this case, the seeds may be all of the same type of seed, or of one or more different types of seed.

### Bioadhesive

As used herein, a bioadhesive is a polymeric material with adhesive properties that has been derived from organic material. Typically, a bioadhesive is fully compostable. Typically, the bioadhesive, as used herein, is also fast drying, such that seeds will not stick to each other after seeds have been further coated and processed.

The bioadhesive comprises one or more protein-containing biomaterials. A protein-containing biomaterial, as used herein, is a protein-containing biological substance, i.e., a protein-containing organic substance, typically a substance containing both proteins and lipids. The biomaterial may be engineered, for example, by a distilling or extracting process from a raw organic material; or may be engineered by treatment of organic material, for example, heating, grinding, milling, compressing, shredding, cooling, crushing, or boiling, to derive a material with desirable characteristics. Desirable characteristics of the biomaterial include, for example, adhesiveness and viscosity. The bioadhesive also comprises an inorganic filler and defoamer.

Typically, the one or more protein-containing biomaterials are selected from brewer's spent grain, distiller's grain, or algal material. Brewer's spent grain and distiller's grain are grain-based ethanol production by-products, wherein brewer's spent grain is derived from barley, and distiller's grain is derived from a mix of corn, rice, and other grains. As used herein, distiller's grain refers collectively to condensed distiller's solubles, distiller's dried grain, distiller's dried grains and solubles, and wet distiller's grain materials.

In the ethanol production process, after fermentation, the resulting ethanol containing mixture (beer) is transferred to distillation columns where the ethanol is separated from the residual “stillage.” The stillage is sent through a centrifuge that separates the solids from the liquids. The liquids, or solubles, are then concentrated to a semisolid state by evaporation, resulting in condensed distiller's solubles (CDS) or “syrup.” When the residual coarse grain solids and the CDS are mixed together and dried, this produces distiller's dried grain with solubles (DDGS). In the cases where CDS is not readded to the residual grains, the grain's solid product is called distiller's dried grain (DDG). If, for example, the distiller's grain is intended as feed for livestock in close proximity to the ethanol production facility, the drying step can be avoided, and the products are called wet distiller's grain (WDG).

As used herein, algal material is material derived from algae, wherein the algae may be, but is not limited to, one or more of green-blue algae, red algae, brown algae, or biodiesel by-product of algae. Algae biomass is an alternative to petroleum-based fuels. Algae biomass contains lipids, proteins, and carbohydrates that can be processed into fuels or other valuable coproducts through chemical, biochemical, or thermochemical means. Algae can be effectively grown in wastewater, so its growth has a very low impact environmentally.

Preferably the bioadhesive comprises a mixture of protein containing biomaterials derived from different organic materials.

Preferably, the one or more protein containing biomaterials comprise distiller's grain or brewer's spent grain (BSG). These are all waste products from standard ethanol production methods. Ethanol production is a large industry, with an estimated 140-150 million metric tons of grain used globally for ethanol production in 2010 alone. Therefore, these by-products are widely available and inexpensive materials.

In the case of BSG, the liquid component may be directly extracted from wet BSG from vicinal breweries to derive the bioadhesive. This is advantageous, as the wet nature of BSG means that it only has a short lifespan before it is “spoiled” for use. This means that any direct use can avoid further waste of the material, without having to employ a highly energy consumptive drying technique.

More preferably, the one or more protein-containing biomaterials comprise brewer's spend grain extract.

The inorganic filler which is used in the bioadhesive is typically selected from a calcium-containing material, for example, calcium oxide, calcium hydroxide, calcium chloride, calcium carbonate, calcium sulfate, or mixtures thereof. Preferably calcium oxide and/or calcium sulfate are used, as these are materials which can dewater during the blending process.

The defoamer is typically selected from a food grade defoamer used in the milk processing or protein processing industries. Preferred examples include mineral oil, silicon oil, vegetable oil and white oil. Combinations of these defoamers may be used.

In addition to the organic material, inorganic filler, and defoamer, the bioadhesive may optionally comprise a crosslinking agent. The crosslinking agent is typically selected from an organic polymeric material with crosslinkable groups (for example, polyisocyanate or epoxy resin) or an inorganic material (for example, silicates or borates). Mixtures of one or more crosslinking agents, including mixtures of one or more organic polymeric materials and/or one or more inorganic materials, may be used.

Preferably the crosslinking agent used herein is polymeric isocyanate, wherein the polyisocyanate functional groups used may be one or more of PMDI (polymeric methylene diphenyl diisocyanate) and PHDI (polymeric hexamethylene diisocyanate isocyanurate); or polyurethane prepolymer blocked polyisocyanates, for example, polyisocyanates blocked with phenol or c-caprolactam. A blocked polyisocyanate can be defined as an isocyanate reaction product which is stable at room temperature but dissociates to regenerate isocyanate functionality under the influence of heat around 100° C.-250° C.

Blocked polyisocyanates based on aromatic polyisocyanates dissociate at lower temperatures than those based on aliphatic ones. The dissociation temperatures of blocked polyisocyanates based on commercially utilized blocking agents decrease in this order: alcohols>caprolactam>phenols>methyl ethyl ketoxime>active methylene compounds.

Other crosslinking agents that can be used as described herein include epoxy resins. Epoxy resins, also known as polyepoxides, are a class of reactive prepolymers which contain epoxide groups. Epoxy resins are polymeric or semi-polymeric materials and an important criterion for epoxy resins is the epoxide content. This is commonly expressed as the epoxide number, which is the number of epoxide equivalents in 1 kg of resin (Eq./kg), or as the equivalent weight, which is the weight in grams of resin containing 1 mole equivalent of epoxide (g/mol). One measurement may be simply converted to another.

Equivalent weight (g/mol)=1,000/epoxide number (Eq./kg) (Eq. 1)

Epoxy resins which may be used as described herein include Bisphenol A epoxy resin, Bisphenol F epoxy resin, Aliphatic epoxy resin, and Glycdylamine epoxy resin.

Typically, the viscosity of the bioadhesive as used herein is from 100 mPa·s to 10,000 mPa·s at 20° C. Preferably the viscosity of the bioadhesive is from 100 mPa·s to 1,000 mPa·s at 20° C. Most preferably the viscosity is from 300 mPa·s to 800 mPa·s at 20° C. At this level of viscosity, the adhesive is viscous enough to easily spread across the surface of a seed but does not have low enough viscosity that it will spread across multiple seeds in application, thus binding them together.

The viscosity of the bioadhesive may be adjusted by the addition of thickeners, which may also be waste by-products. Typically, the thickener comprises waste products of the paper industry, for example, lignin sulfates, for example, one or more of potassium lignin sulfate, sodium lignin sulfate, magnesium lignin sulfate, and calcium lignin sulfate. Typically, the thickener is present in the bioadhesive at a ratio of from 0.1% to 10% by weight, relative to the total weight of the bioadhesive.

The bioadhesive as described herein may also comprise a wet strength agent, typically polyamideamine epichlorohydrin (PAE).

Typically, the bioadhesive described herein does not contain formaldehyde. Formaldehyde is a toxic gas that can react with proteins of the body to cause irritation and, in some cases, inflammation of membranes of eyes, nose, and throat. It is a suspected carcinogen, based on laboratory experiments with rats.

The bioadhesive may comprise 20% to 60% by weight solid content, for example, from 20% to 50%, preferably from 30% to 50%, e.g., from 30% to 40% or from 40% to 50%.

Suitable bioadhesives for use in the invention are described in U.S. Pat. No. 10,428,254 B2, the content of which is incorporated herein by reference.

### Bioactive Agent

As used herein, a bioactive agent is a biodegradable, bioderived compound or material which has activity as a repellent, fertilizer, fungicide, or bactericide.

Bioderived, as used herein, implies that the material is derived from plant or animal matter, for example, the bioactive agent may be a compound isolated from plant or animal matter; a material derived or collected from plant, food, or animal waste; bacteria; fungi; or material derived from fossilized plant or animal sources. Preferred bioderived materials include compounds isolated from plant or animal matter, and materials derived or collected from plant, food or animal waste.

Examples of bioactive agents that are repellents are garlic, chili peppers, tomato leaf extract, beer, and citrus rind. Such agents have been shown to be effective against a wide variety of pests such as mites, whiteflies, aphids, beetles, slugs, mice, squirrels, and birds.

The bioactive agent, as described herein, may also protect seeds from disease. For example, the bioactive agent could be a biofungicide, for example, bacterial fungicides, including Bacillus subtilis, Streptomyces lydicus, Pseudomonas fluorescens, or fungal fungicides, including Tricoderma harzianum. In other examples, the bioactive agent may be a bactericide, including Bacillus subtilis and Pseudomonas fluorescens, which also act as fungicides.

The bioactive agent, as described herein, may also be a fertilizer. A bioactive agent which is a fertilizer may be derived from fossilized plant or animal sources, for example, greensand (anaerobic marine deposits), limestone (fossilized shell deposits), and rock phosphates (fossilized guano).

Fertilizers derived from plants may be derived from processed plant waste, for example, decomposing crop waste, or compost. Alternatively, a plant waste-derived fertilizer could be a seaweed or algae extract. In some examples, a plant waste derived fertilizer can be derived from algae, particularly from algae used to capture nitrogen and phosphorus run off from agricultural fields, as this means the algae is rich with nutrients necessary for plant growth.

Fertilizers derived from animal products can include by-products of animal slaughter which have been refined, for example, blood meal, bone meal, fish meal, and feather meal. Alternatively, fertilizers can be derived from animal waste, including chicken litter, which is a mixture of chicken manure and sawdust, and insect frass (herein, frass), as discussed below.

Preferably, the bioactive agent is a compound isolated from plant or animal matter or a material derived or collected from plant, food, or animal waste. More preferably, the bioactive agent is derived or collected from plant, food, or animal waste, in particular, the bioactive agent as used in the invention is frass. Preferably, the bioactive agent comprises chitin. Frass is an example of a bioactive agent which comprises chitin.

Preferably the bioactive agent, as used herein, is in particulate form. This can allow for a more even seed coating, which can lead to easier seed distribution and more complete protection across the whole surface area of the seed.

Particle size as defined herein is the maximum distance across a particle. Particle size in the case of a composition containing a plurality of particles, is defined as the average particle size.

Average particle size within a composition may be measured by laser diffraction particle size analysis, for example, using a Mastersizer laser diffraction analyzer by Malvern Panalytical, which can produce accurate particle size distributions for both wet and dry particle dispersion. Alternatively, the particle size may be monitored and controlled using a sieving method with standard mesh size.

Typically, the bioactive agent as described herein has an average particle size of 500 microns or less, for example, 200 microns or less, 180 microns or less, 150 microns or less, or 100 microns or less. Preferably the bioactive agent has an average particle size of 100 microns or less, for example, 90 microns or less, or 80 microns or less. Typically, the bioactive agent has an average particle size of 10 microns or more, for example, 20 microns or more, or 50 microns or more. Typically, the bioactive agent has an average particle size of from 10 microns to 500 microns, preferably 10 microns to 200 microns, more preferably 100 microns to 200 microns.

Such particle sizes are beneficial as they may more easily be absorbed by the seed. This allows improved growth due to nutrients being directly absorbed by the seed, and improved protection from pests, as the inner structure of the seed is protected as well as the surface. Such particle sizes also allow for a more even coating of the seed. An even coating allows for more facile distribution of seeds.

### FRASS

As used herein, frass is excrement or other refuse left by insects and insect larvae. Frass can comprise solid excrement, chewed or mined refuse, larvae exoskeletons, or similar solid refuse left by insects or insect larvae. The nature of frass can be dependent on the species that has generated the frass, and the diet of the species that has generated the frass.

The frass used in the invention may be frass from any insect, for example, aphids, beetles, caterpillars, worms, grasshoppers, locusts, thrips, weevils, flies, whiteflies, mites, and lice. The frass used in the invention may typically be frass from one or more of locusts, crickets, mealworms, black soldier flies, black soldier fly larvae, common houseflies, and common housefly larvae.

Locusts, crickets, mealworms, black soldier flies, black soldier fly larvae, common houseflies, and common housefly larvae, are currently being successfully farmed globally for food and feed purposes. Due to their ability to be fed on food waste, their high waste degradation efficiency and their efficiency as organic cyclers, the mass rearing of such insects offers major opportunities for large-scale production of protein for feed and food. Large-scale production of feed and food via insect farming has less environmental impact than animal production and can offer socioeconomic benefits for local businesses at any production scale.

Preferably the frass is frass from black soldier fly larvae. Black soldier fly larvae have high waste degradation efficiency (66%-79%) and an ability to significantly reduce pathogens present in waste, meaning they are efficient organic cyclers that may also benefit soil fertility. The frass from black soldier fly larvae has been demonstrated herein to improve root growth and increase weight of biomass of Brassica seeds and seedlings, compared to seeds not coated by frass.

The frass may be frass derived from insects fed a diet wholly or partly comprising organic waste.

As used herein, organic waste is any material that is a waste product of either a plant or an animal. Organic waste includes but is not limited to green waste, food waste, food-soiled paper, nonhazardous wood waste, and landscape and pruning waste. As used herein, green waste is organic waste that can be composted.

Food waste may be any food or feed, including inedible parts of food or feed, which is removed from the food supply chain to be recovered or disposed of. Food waste includes but is not limited to compost, crops spoilt by pests, crops ploughed in, crops not harvested, food wasted through overstocking, food not selected by consumers, food unable to be sold due to exceeding expiration dates, spoiled food, and food purchased by consumers but not consumed. The use of food waste as a feed for insects is advantageous, as it is widely available and inexpensive, with the use as a feed also reducing buildup of food waste in landfill sites.

Preferably the frass may be frass derived from insects fed a diet wholly or partly comprising food waste. Examples of suitable food waste include acidic food waste, for example, fruit waste, for example, orange waste and lemon waste. Frass derived from insects fed a diet of acidic food waste can be especially beneficial, as the frass maintains some of the acidity of the waste. Acidity is desirable as a higher proportion of nutrients are in an absorbable form and there is higher beneficial microbial activity in soil with a mildly acidic pH.

More preferably the frass may be frass derived from insects fed a diet wholly or partly comprising nutrient-rich food waste. When insects are fed with a diet of nutrient-rich food waste, the frass they produce is also rich in nutrients. These nutrients can include but are not limited to nitrogen, phosphorus, potassium, iron, calcium, zinc, boron, manganese, magnesium, and copper. Each of these nutrients are key to the successful growth of plants, for example, nitrogen is a key component of chlorophyll; phosphorus is a key component of ATP, which is essential for converting other nutrients into useful products; and potassium plays a major role in the regulation of water in plants. Frass derived from insects fed on a diet comprising organic biomass is also beneficial as it provides a good microenvironment in which seeds can grow. A fertilizer which naturally contains such a range of nutrients, without any additives, is extremely advantageous as it supports improved growth and health of plants through many mechanisms simultaneously.

Even more preferably the frass may be frass derived from insects fed a diet wholly or partly comprising orange waste. Orange waste degrades slowly compared with other organic waste, so it is beneficial to avoid large quantities of orange waste in landfill. Orange waste is also rich in nutrients, therefore an insect fed with a diet wholly or partially comprising orange waste will produce nutrient rich frass.

Preferably the frass as described herein comprises chitin. Chitin is a fibrous substance consisting of polysaccharides. Chitin is a major constituent in the exoskeleton of some insects and the cell walls of fungi.

As chitin is commonly found in plant-eating insects, a plant exposed to chitin (e.g., through frass) may behave as though there is an imminent insect attack, upregulating the plant's defensive mechanisms through systemic induced resistance and releasing chitinases to break down the chitin. Results of inducing these defensive mechanisms can vary from species to species. Results of inducing these defense mechanisms may include, but are not limited to, bushier growth, thicker leaves, and strong, early blooming and fruiting.

As chitin is commonly found in fungal pathogens, a plant exposed to chitin (e.g., through frass) may also be protected from diseases associated with such fungal pathogens. These diseases include, but are not limited to, blights, rusts, and mildews.

The chitin content of the bioactive agent (e.g., frass) may be determined using Fourier-transform infrared spectroscopy (FTIR). The chitin content of frass may be used as an indication of the quality of the frass as described herein. The chitin content of frass may be measured by assessing the absorbance at 1,659 cm⁻¹ and/or 1,380 cm⁻¹. These are the characteristic absorbances for the amide bond (CO—NH) and the C—N bond of chitin respectively. Alternatively, when chitin has been confirmed to be present in the bioactive agent (e.g., frass) by FTIR, elemental analysis can be used to establish the nitrogen levels present. Analysis of the nitrogen content may be used to give a quantitative estimate of chitin levels in the bioactive agent (e.g., frass).

The frass as described herein may be particulate frass.

Typically, the frass has an average particle size of 500 microns or less, for example, 200 microns or less, 180 microns or less, 150 microns or less, or 100 microns or less. Preferably the frass has an average particle size of 100 microns or less, for example, 90 microns or less, or 80 microns or less. Typically, the frass has an average particle size of 10 microns or more, for example, 20 microns or more, or 50 microns or more. Typically, the frass has an average particle size of from 10 microns to 500 microns, preferably 10 microns to 200 microns, more preferably 100 microns to 200 microns.

Particle sizes of from 10 microns to 200 microns, or 100 microns to 200 microns is preferable as frass of this size may be more easily absorbed by the seed. This allows improved growth due to nutrients being directly absorbed by the seed, and improved protection from pests, as the inner structure of the seed is protected as well as the surface. Frass of this size also allows for a more even coating of the seed. An even coating allows for more facile distribution of seeds.

The frass as described herein may be prepared by microionization or milling. Microionization may be carried out by wet or dry homogenization, or any other suitable technique. Milling of frass may be performed by any appropriate milling technique. Appropriate milling techniques include, but are not limited to, wet milling and jet milling. Alternatively, the frass may be prepared by grinding.

### Coated Seed

A coating, as referred to herein, is a covering that is applied to the surface of a seed. As described herein, the coating may fully cover the surface of a seed, or it may partially cover the seed. Preferably the coating fully covers the seed.

A coated seed may have up to 100% of the surface area of a seed covered with a coating, for example, 100%, 95%, 90%, 80%, or 70%. Preferably, a coated seed has at least 70%, 80%, or 90% of the surface area of the seed covered with the coating. Thus, for example, 70%-100%, 80%-100% or 90%-100% of the surface area of the seed is coated. In some embodiments the coated seed is coated with a coating resin, as discussed below. In some embodiments it is coated in a layer of bioadhesive and a layer of bioactive agent, wherein these layers may be distinct, or wholly or partly mixed.

Typically, the weight ratio of coating to seed (wt. coating:wt. seed) is from 1:1 to 1:100, for example, from 1:2 to 1:80. Preferably the weight ratio of coating to seed is from 1:4 to 1:60, more preferably 1:10 to 1:60. In some embodiments, the coating to seed weight ratio of the coated seed is 1:2 to 1:10, preferably 1:4 to 1:10. In some preferred embodiments, the coating to seed weight ratio may be 1:3 to 1:7, for example, 1:3 to 1:4, 1:4 to 1:5, 1:5 to 1:6 or 1:6 to 1:7.

The coating weight in a weight ratio of coating to seed refers to the weight of the coating material disclosed herein, i.e., the combined weight of bioadhesive plus bioactive agent, or the coating resin. As desired, additional coating layers may be applied either on the inventive coating or between the seed and the inventive coating. In that case, such additional coatings are not included in the weight of the coating when calculating the coating to seed weight ratio.

Typically, the coating comprises from 1 wt. % to 60 wt. % bioactive agent(s) with reference to the total weight of the coating, preferably from 10 wt. % to 40 wt. %, more preferably from 20 wt. % to 30 wt. % bioactive agent(s). Typically, the coated seed has a weight ratio of bioactive agent(s) to seed (wt. bioactive agent:wt. seed) of from 1:4 to 1:400, for example, from 1:8 to 1:240. Preferably the weight ratio of bioactive agent(s) to seed is from 1:16 to 1:240, more preferably 1:40 to 1:240.

Typically, larger relative amounts of bioactive agent are used wherein the bioactive agent comprises bioderived materials which are compounds isolated from plant or animal matter and/or materials derived or collected from plant, food, or animal waste. For example, when the bioactive agent is frass, coated seeds with a weight ratio of frass:seed of from 1:4 to 1:40, for example, 1:4 to 1:20, preferably 1:8 to 1:12, have improved root growth, and increased weight of biomass compared to uncoated seeds grown in the same conditions, without affecting the germination rate. Coated seeds with an increased weight ratio of frass to seed may improve protection against pests.

Typically, the coated seed has a coat with an average thickness of from 100 microns to 2,000 microns. Preferably the coating has an average thickness of from 200 microns to 1,000 microns. Most preferably the coating has an average thickness from 200 to 500 microns.

### Coating Resin

The invention also provides a coating resin comprising a mixture of the bioactive agent as described herein and bioadhesive as described herein. Preferably, the coating resin comprises the bioactive agent(s) in an amount of from 1 wt. % to 60 wt. % with reference to the total weight of the coating resin, preferably from 10 wt. % to 40 wt. %, more preferably from 20 wt. % to 30 wt. %.

The mixing to form the resin of the invention may be performed by one or more of tumbling, blending, homogenization, mechanical homogenization, emulsifying through a fine mesh or any other suitable method. Preferably the resin is mechanically homogenized and passed through a fine mesh, as this ensures good suspension and storage stability of the resin.

The bioactive agent and the bioadhesive may be mixed such that they are homogenized. Typically, the coating resin is a homogenized mixture of frass and bioadhesive. The frass and bioadhesive may be homogenized preferably using industrial mechanical homogenization equipment, for example, colloid mills and emulsification equipment. Homogenization may also be performed by a food blender, food processor, laboratory homogenizer, or any other appropriate method. If initially too large for homogenization frass may first be milled or micronized as described above.

Homogenization is advantageous as a homogenized mixture leads to more even distribution of bioactive agent on the coating. A more even distribution of bioactive agent may mean more even absorption of bioactive agent by the seed and more even protection, such that all areas of the seed have roughly equal protection, and there are no weaker points whereby a pest could reach the seed. Additionally, homogenization of the resin may lead to a smoother seed coating, which may aid in seed distribution.

### Coating Process

The invention also provides processes for coating seed with a coating comprising one or more bioactive agents and bioadhesive. The process comprises applying to a seed the bioactive agent(s), as described herein, and a bioadhesive, as described herein, and forming a coating on the seed. The application of bioadhesive and bioactive agent typically directly forms the coating on the seed, such that a separate step of forming a coating following application is not required. Preferably the coating comprises frass and a bioadhesive.

In some embodiments of the invention the seed is coated with bioactive agent(s) and bioadhesive that have been premixed, for example, frass and bioadhesive that have been premixed. As used herein, a mixture of one or more bioactive agents and bioadhesive is referred to as a coating resin, as described above.

In some embodiments of the invention a seed is first coated with a layer of bioadhesive and then a layer of bioactive agent(s), for example, a layer of frass. For instance, a seed may first be coated with bioadhesive and then the bioadhesive coated seed may be mixed with one or more bioactive agents. In some embodiments the layers may be distinct from each other, in other embodiments the two layers may be partially or wholly mixed.

When coating seeds with one or more of the coating resin, bioadhesive, and/or bioactive agent(s), any suitable coating technique may be used. For instance, coating may be carried out by rotary coating, dry powder application, drum coating, or seed pelleting, in particular by rotary coating or drum coating.

The coating process of the invention, particularly wherein the coating technique is seed pelletization, may provide seeds which are more uniform in shape and/or larger and/or heavier. These properties can aid in ease of seed distribution. Techniques such as seed pelletization, which increase weight and size of seeds, can be especially useful for light and small seeds, for example, grass seeds.

The coating process of the invention may result in up to 100% of the surface area of a seed being covered with a coating, for example, 100%, 95%, 90%, 80%, or 70%. Preferably, the coating process will result in at least 70%, 80%, or 90% of the surface area of the seed being covered with the coating. Preferably, the coverage is from 70% to 100%, as this level of coverage leads to better distribution of bioactive agent on the seed surface and therefore more complete protection from pests. Additionally, more coverage leads to a more even coating of the seed, therefore increasing ease of seed distribution and uniformity of crop.

Typically, the seed coating material is mixed with the seeds at a ratio of wt. coating:wt. seed from 1:1 to 1:100, for example, from 1:2 to 1:80. Preferably the weight ratio of seed coating materials to seed is from 1:4 to 1:60, most preferably 1:10 to 1:60. In some embodiments, the seeding coating material and seeds are mixed at a coating material to seed weight ratio of 1:2 to 1:10, preferably 1:4 to 1:10. In some preferred embodiments, the ratio of seed coating material to seed is 1:3 to 1:7, for example, 1:3 to 1:4, 1:4 to 1:5, 1:5 to 1:6 or 1:6 to 1:7.

As used herein, seed coating material comprises all material used to coat the seed, including the bioadhesive and bioactive agent(s), whether provided in combination as a coating resin or separately. Other coatings may be applied to the seed other than the coating of the invention. The weight of such coatings is not typically included in the weight ratio of seed coating materials to seed.

Typically, the bioactive agent(s) comprises from 1% to 60% wt. of the total weight of the seed coating material. Preferably, the bioactive agent(s) comprises 10%-40% wt. of the seed coating material. More preferably, the bioactive agent(s) comprises 20% to 30% wt. of the seed coating material. Typically, the coating process uses a weight ratio of bioactive agent(s) to seed (wt. bioactive agent:wt. seed) of from 1:4 to 1:400, for example, from 1:8 to 1:240. Preferably the weight ratio of bioactive agent(s) to seed is from 1:16 to 1:240, more preferably 1:40 to 1:240.

### Kit

The invention also provides a kit comprising one or more bioactive agents as described herein and bioadhesive as described herein. The bioactive agent(s) and bioadhesive of the kit may be provided in the form of the coating resin as described above. In this embodiment, the kit may be used by directly applying the resin to a seed before planting.

In other embodiments, the kit may comprise separately one or more bioactive agent(s), as described herein, and bioadhesive, as described herein. Where multiple bioactive agents are present, these may be provided in combination or separately from one another. For example, the kit may comprise separately frass, and a bioadhesive. The bioactive agent(s) and bioadhesive are typically provided in separate containers or packages. The bioadhesive and bioactive agent(s) may be mixed to form a coating resin before coating seeds. Alternatively, seeds may be coated in the bioadhesive and subsequently with the bioactive agent(s).

The kit may also comprise seeds, as described herein, which also may be provided in a separate package or container.

Preferably, the kit comprises the bioactive agent(s) in an amount of from 1 wt. % to 60 wt. % with reference to the total weight of bioactive agent(s) and bioadhesive provided in the kit, preferably from 10 wt. % to 40 wt. %, more preferably from 20 wt. % to 30 wt. %.

### Uses of the Coated Seed

The coated seed of the invention, or any coated seed obtained by utilizing the other aspects of the invention, may be planted in the same way as an uncoated seed. The seed may be cared for as any uncoated seed may be, for example, with watering, or with treatment by additional fertilizers or pesticides. The plant or crop that results from the growth of the coated seed may then be harvested as any uncoated seed may be.

A coated seed of the invention may have improved growth, particularly when the bioactive agent of the coating is, amongst its other properties, a fertilizer, for example, frass. Frass comprises digested plants, and therefore comprises nutrients necessary for plants to grow, as discussed above. Frass also comprises beneficial microbes from the guts of insects, which can improve plant growth. Therefore, when the coated seed of the invention is a frasscoated seed, it may have improved growth.

A coated seed of the invention may also repel pests, experience reduced damage from pests, and experience reduced damage from disease. However, the coating may still support key pollinators, like bees and butterflies, while simultaneously acting as deterrent for pests, for example, plant-eating insects. This is advantageous over alternative repellents which may be less selective. Frass is an example of a more selective repellent with can be used in the coating of the invention. Frass can be an efficient deterrent without damage to the general insect population, and without the great repercussions for the biosphere that such damage can lead to.

A pest, as referred to herein, may be an animal or plant. Typically, herein, the pest is an insect. Insect pests include but are not limited to aphids, beetles, caterpillars, worms, grasshoppers, locusts, thrips, weevils, flies, whiteflies, mites, lice. A pest, as referred to herein, may also be a mollusk, for example, a snail or slug.

In one example, wherein the bioactive agent is frass, seeds and resulting plants may repel cabbage stem flea beetle (CSFB). The ability of a pesticide specifically to target the CSFB is particularly advantageous. The CSFB commonly affects vegetable brassicas, for example, cabbage and kale. It is also increasingly associated with damage to baby leaf salad crops, where the damage can be to the extent that the crops are unsuitable for sale and consumption.

In particular, the CSFB cause damage to oil seed rape at its emergence. Damage from pests at this stage in the cycle of plant can lead to crop failure. This makes the need for a pest repellent that can act from the point of germination especially important with regard to oil seed rape.

The coated seed of the invention, and the resulting plant, may also have a boosted natural immune system, and protection from diseases. This effect is provided partly by chitin as discussed above. The diseases that the coated seed of the invention provides protection from may be fungal, viral, or bacterial. For example, fungal diseases such as blights, rusts, mildews, light leaf spot, and phoma stem canker; viral diseases such as turnip yellow virus; and bacterial diseases such as black rot.

In particular, a seed coated with a bioactive agent such as frass which contains chitin is very effective in protection from fungal diseases. As discussed above, this protection may be due to chitin being commonly found in fungal pathogens. Resistance against fungal pathogens is particularly of interest in terms of Brassicas, especially oil seed rape, where the fungal disease light leaf spot, if left untreated, can lead to crop losses of 1 metric ton per hectare (0.1 kg/m²).

### EXAMPLES

### Example 1: Discussion of Bioadhesive and Frass Used in Further Examples

The bioadhesive used for the following examples comprised brewer's spent grain extract (80 g, 20% wt. solid content), magnesium lignin sulfate powder (10 g), and calcium sulfate (10 g), to have a total solid content of 36% wt. The ingredients were all thoroughly mixed and blended, and 0.5% wt. of defoaming agent was added, for example, vegetable oils or wax.

The frass used for the following examples has Soil Association certification. The frass was obtained from AgriGrub and was ground and sieved in a sieve of standard mesh size to give a fine powder with an average particle size of 100 microns. The frass was then combined with the bioadhesive as discussed above.

The frass underwent FTIR analysis. Absorbance at 1,659 cm⁻¹ and 1,380 cm⁻¹ was observed, characteristic of the amide bond (CO—NH) and C—N bond of chitin, and therefore demonstrated the frass used in the examples comprised chitin.

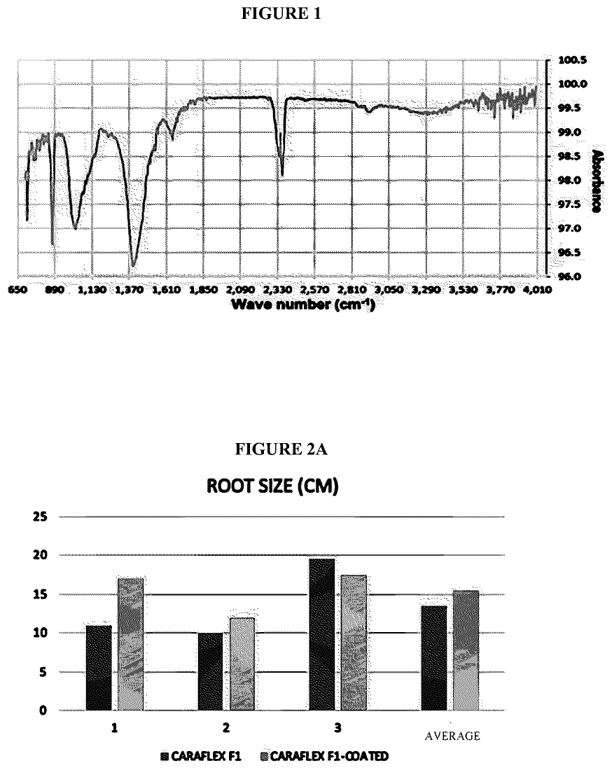

The FTIR spectrum is depicted in FIG. 1.

### Example 2: Germination Experiments

The seeds of the following examples were evaluated as described herein, within the guidelines of the Seeds Act (1966).

Initially, the seeds are placed in compost, under moist conditions and then maintained at a temperature of between 24° C. and 30° C., for at least seven days, wherein the variation in temperature should not exceed 0.6° C. At the end of this period the seeds are categorized as normal, abnormal, diseased, dead, or hard. The germination rate is calculated from the percentage of normal seedlings from the total number of seeds evaluated. This is the standard warm germination test.

To maintain the temperature of the seeds, it is appropriate to use cabinet seed germinators or walk-in germinators. To determine the germination rate, appropriate counting devices for use include counting boards, automatic seed counters, and vacuum seed counters. The germination rate needs to be evaluated at the end of the germination period.

During the analysis of the seeds, it is essential that the equipment is checked regularly to ensure the germinators are maintained at the correct temperature. Similarly, it must be ensured that the relative humidity inside the germinator is maintained at from 90% to 98%; that the phytosanitary conditions of the germinators are adequate; that the germinators are periodically disinfected; and that the walls of the germinators are devoid of cracks, crevices, insects, fungi, or bacteria.

When handling the seeds, it is important that the medium in which the seeds are planted is nontoxic, free from mold and other microorganisms, and provides adequate aeration and moisture. Preferably the medium is tested for phytotoxicity before the germination experiments take place.

If, at the end of the prescribed test period, seeds have only just begun to germinate, the test may be extended in periods of seven days. Seedlings may have to be removed and counted at more frequent intervals during the prescribed period of the test when a sample is infected with fungi or bacteria. Seeds that are obviously dead and decaying, and may, therefore, be a source of contamination for healthy seeds, should be removed at each count and the number recorded.

### Example 3: Growth Comparison Between Coated and Uncoated Seeds (OSR)

The bioadhesive as described in Example 1 was micronized, by wet homogenization, using homogenization equipment from Silverson Machines Ltd. and combined with frass to coat oil seed rape seeds with different amounts of frass as described in Example 1.

Each sample included 20 g seeds, i.e., approximately 100 seeds. Sample 1 was coated with 3.3 g bioadhesive and 1 g to 2 g frass. Sample 2 was coated with 3.3 g bioadhesive and 2 g to 5 g frass. Coating was carried out using rotary coating.

Each sample was planted in a plastic tray with compost as soil. A control group of approximately 200 seeds without any coating was also planted.

After 7 days, around 90% to 94% of control seeds had germinated, and around 70% of treated seeds (across both sample groups) had germinated.

Germination rate after 7 days was tested by a standard warm germination test, as described above.

After 21 days, full germination for all groups of seeds had been achieved.

The delayed germination was considered to be due to the coating of frass on the seeds.

After 30 days, 100 germinated plants from each sample were taken from the soil and washed with water to remove any soil residue. The length of the root was measured, and the total dry biomass was weighed.

The following data was collected:

TABLE 1

| | Total Dry Biomass (for 100 Seeds | |
|---|---|---|
| Sample | After 30 Days' Growth) | Average Root Length |
| Control | 0.21 g | 10 cm |
| Sample 1 | 0.39 g | 13 cm |
| Sample 2 | 0.45 g | 11 cm |

### Example 4: Growth Comparison Between Coated and Uncoated Seed (Other Brassica Seeds)

A further four varieties of Brassica seeds were coated as described in Example 3, with the bioadhesive and frass as described in Example 1. The seeds that were coated were Caraflex F1, Famosa F1, Covina F1, and Redbor F1. 24 seeds of each variety were planted in trays, each with 24 cells, i.e., one seed per cell in a tray. 24 uncoated seeds of each variety were also planted in separate 24 cell trays.

After one month of growth, 3 fully germinated seeds were taken at random from each tray. The root length of each of these seeds was measured and the average root length is displayed in the table below.

TABLE 2

| | | Sample Root | Average Root |
|---|---|---|---|
| Seed Variety | Samples | Length (cm) | Length (cm) |
| Caraflex F1 (uncoated) | Sample 1 | 11.0 | 13.5 |
| | Sample 2 | 10.0 | |
| | Sample 3 | 19.5 | |
| Caraflex F1 (coated) | Sample 1 | 17.0 | 15.5 |
| | Sample 2 | 12.0 | |
| | Sample 3 | 17.5 | |
| Famosa F1 (uncoated) | Sample 1 | 6.5 | 6.8 |
| | Sample 2 | 7.5 | |
| | Sample 3 | 6.5 | |
| Famosa F1 (coated) | Sample 1 | 8.0 | 8.3 |
| | Sample 2 | 10.5 | |
| | Sample 3 | 6.4 | |
| Covina F1 (uncoated) | Sample 1 | 15.5 | 10.3 |
| | Sample 2 | 5.0 | |
| | Sample 3 | 10.5 | |
| Covina F1 (coated) | Sample 1 | 16.5 | 14.2 |
| | Sample 2 | 14.5 | |
| | Sample 3 | 11.5 | |
| Redbor F1 (uncoated) | Sample 1 | 8.5 | 11.8 |
| | Sample 2 | 14.0 | |
| | Sample 3 | 13.0 | |
| Redbor F1 (coated•) | Sample 1 | 9.5 | 14.2 |
| | Sample 2 | 16.0 | |
| | Sample 3 | 17.0 | |

•It was observed that the germinated leaf of one coated seed from this set had changed from red to green. To ensure this was not an anomaly the experiment with Redbor F1 (coated) was repeated. The same result was observed. This indicated direct interaction of frass with the seed.

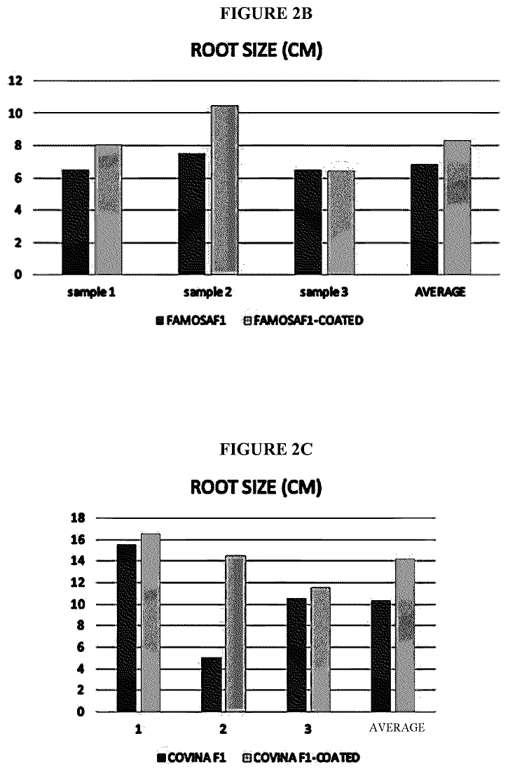

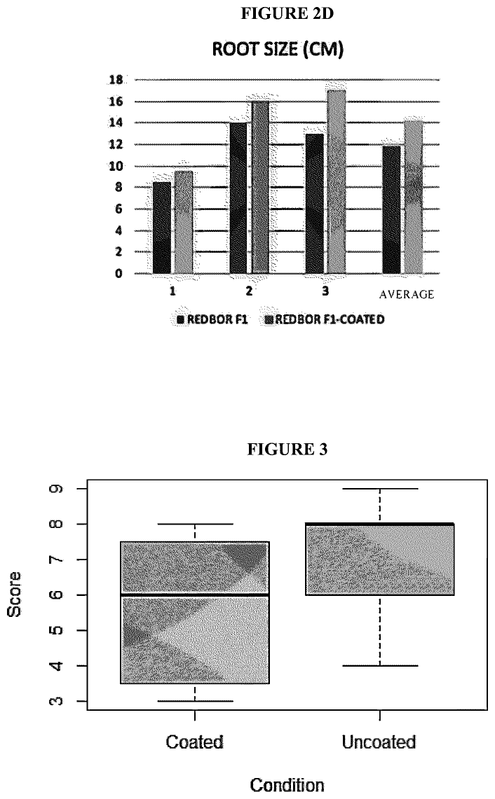

Results are also depicted in FIGS. 2A-2D.

### Example 5: Effect of Frass on Germination and Growth of Seeds Over 21 Days

After the results of Example 3, further investigation was carried out to determine the effect of frass on initial germination.

Two samples of 20 g of oil seed rape seeds each were coated with 3.3 g of bioadhesive and further coated with 2 g (sample 1) and 5 g (sample 2) of frass powder respectively. These were then planted in trays as described in Example 3. A control group of 20 g of uncoated oil seed rape seeds was also planted.

After 21 days, the germination was measured using the standard method as described in Example 3. The germination rate for the control group was 100%, the germination rate for sample 1 was also 100%, the germination rate for sample 2 was 83%. Optimal germination can therefore be achieved with a frass coating which is at least 2 g but less than 5 g frass per 20 g seed.

Measurements were also taken to determine if the range of coating masses had an effect on growth of germinated seeds. For each sample the fresh weight of leaf and of stem and root were measured, and the mean averages calculated. Total dry biomass of leaf and of stem and root were also measured, and the mean averages calculated. Length of root was also measured. The results are recorded in the table below.

TABLE 3

| | | Fresh Weight of | | Dry Total Biomass | | |
|---|---|---|---|---|---|---|
| | | Plant (Average) | | Weight (Average) | | Length of |
| Group | Germination | | Stem and | | Stem and | Root (cm) |
| Name | Rate (%) | Leaf (g) | Root (g) | Leaf (g) | Root (g) | (Average) |
| Control | 100 | 3.70 | 7.74 | 0.159 | 0.209 | 17 |
| Sample 1 | 100 | 4.45 | 7.82 | 0.168 | 0.238 | 23 |
| Sample 2 | 83 | 3.85 | 8.10 | 0.154 | 0.231 | 22 |

As can be seen from the data in the above table, the reduced germination rate did not have a negative impact on overall plant growth. Additionally, the data indicated that increase in growth does not correlate directly with increase in mass of frass used for coating of seeds. Instead, the data suggests that the mass of frass used for coating can be optimized to give maximum growth, with the data indicating that the optimum mass ratio is likely to be around 1:10*wt.*frass:wt.*seed.

### Example 6: Protocol for Germination

Germination of seedlings begins on a damp paper towel, held within a small container and covered on top with foils, in conditions as described in Example 2. The seedlings are exposed to air and light for several minutes each day until they have germinated. After this germination period, they are transferred into soil (sowed) and continue to grow. The germination period usually takes up to 4 days before the seedlings are transferred to the soil.

### Example 7: Protocol for Assessing Pest-Repellent Properties

After the initial germination period (4 days), described in Example 6, seedlings are transferred to soil, and are subsequently sowed in fields where cabbage stem flea beetles gather during cabbage stem flea beetle season (end of summer). In the case of OSR, crops grow within two weeks of germination.

### Damage Scoring

Damage scoring is assessed by eye during the growing period. It is assessed on a scale of 1 (little or no damage) to 10 (completely destroyed). This damage is assessed within a week of exposure to cabbage stem flea beetles. No formal measurements are taken at this time, and crops are left to grow. If there is significant change in the damage to the group, damage scoring may be carried out at multiple times at different stages. The scores for coated and uncoated crops are then compared with one another.

### Hole Diameter

After a period of time, crops are removed from the soil, the leaves are cut from the roots, pressed flat using a cold press, and photographed next to a ruler. Using these photographs with a software called ImageJ, measurements are taken for the diameter of holes (in mm) and compared between coated and uncoated leaves. Diameter is an accurate indicated of hole size, as cabbage stem flea beetles inflict circular bites.

### Example 8: Protocols for Assessing Biostimulant Properties

After germination as described in Example 6, crops are transferred to soil in fields as described in Example 7.

### Root Length

After a certain time period, the crops are removed from the soil and washed to remove the dirt from the roots. They are then laid flat and straight and photographed next to a ruler. ImageJ software is used for accurate measurements (in mm) of root length. Average root lengths of roots derived from coated and uncoated seeds are compared.

### Cotyledon Diameter

To measure cotyledon diameter, cotyledon may be traced on graph paper and ImageJ used to measure the length (in mm) from the top of the stem to the furthest edge of the leaf. Alternatively, leaves may be cut from the soil and cold pressed to become flat. They are photographed next to a rule, then ImageJ is used to accurately measure (in mm) the diameter of the leaves. Due to the shape of the leaves, two measurements are taken either side of the furthest point from where the leaf was cut.

In the examples which follow, the bioactive agent (frass) and bioadhesive used are as described in Example 1. The coating material provided uses bioactive agent (frass) and bioadhesive in equal proportions. The coating material was prepared, and the seeds were coated using the method as described in Example 3. The weight ratio of the seed coating material to seed used in the coating step is specified in each example (as “frasscoat ratio”).

### Example 9: Pest-Repellent Test of Aurelia OSR Seeds (Damage Scoring on Day 14)

Three trays of uncoated and coated Aurelia OSR seedlings (G3) underwent the germination procedure as described in Example 6 and were sown on July 6, wherein the coated seeds had frasscoat ratio of 1:6. On day 8 after sowing, the G3 seedlings were taken to a field trial center and replanted as described in Example 7. On day 10 a total of 12/36 coated seedlings and 16/36 uncoated seedlings had germinated.

Damage scoring (as described in Example 7) was carried out on day 14 and followed by a two-sample one-tailed t-test. As shown in FIG. 3 the % damage score of the G3 coated seeds was significantly less than the G3 uncoated seeds (two-sample one-tailed t-test, p=0.03542).

### Example 10: Pest-Repellent Test of Aurelia OSR Seeds (Damage Scoring on Day 12)

Three trays of uncoated and coated Aurelia OSR seedlings (G4) underwent the germination procedure as described in Example 6 and were sown on July 11, wherein the coated seeds had a frasscoat ratio of 1:6. On day 3 after sowing, the G4 seedlings were taken to a field trial center and replanted as described in Example 7. On day 10 a total of 24/36 coated seedlings and 22/36 uncoated seedlings had germinated.

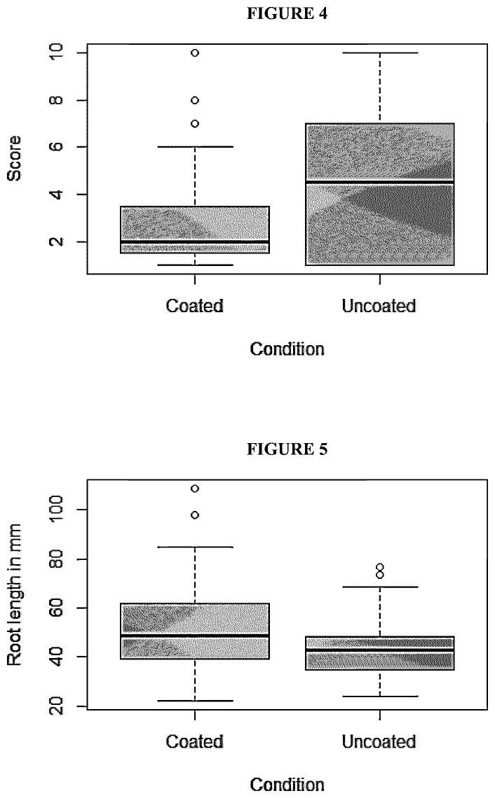

Damage scoring (as described in Example 7) was carried out on day 12 and followed by a two-sample one-tailed t-test. As shown in FIG. 4 the % damage score of the G4 coated seeds was less than the G4 uncoated seeds (two-sample one-tailed t-test, p=0.05522).

### Example 11: Biostimulant Test of Aurelia OSR Seeds (Control)

Uncoated and coated Aurelia OSR seedlings (G6) underwent the germination procedure as described in Example 6 and were sown on July 14, wherein the coated seeds had a frasscoat ratio of 1:6. G6 were put in a lab with low light conditions. On day 10 after sowing, a total of 24/36 coated seedlings and 26/36 uncoated seedlings had germinated.

No scoring was carried out due to G6 being the lab control. Instead, root length and cotyledon diameter were recorded on day 26, as described in Example 8. Each were followed by a two-sample one-tailed t-test.

As shown in FIG. 5, the root lengths of the G6 coated seeds were significantly greater than the G6 uncoated seeds (two-sample one-tailed t-test, p=0.04453).

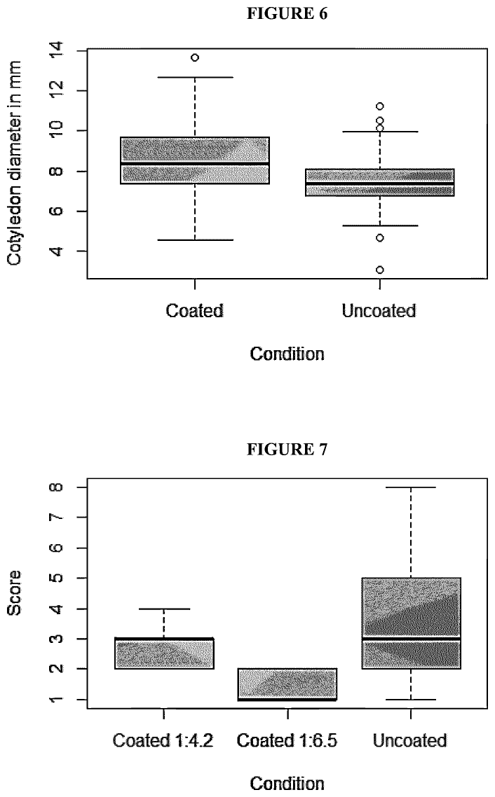

As shown in FIG. 6, the cotyledon diameters of the G6 coated seeds were significantly greater than the G6 uncoated seeds (two-sample one-tailed t-test, p=6.306×10⁻⁷).

### Example 12: Pest-Repellent Test of Acacia OSR Seeds with Different Frasscoat Ratios

Acacia OSR seeds (G7 and G8) were grouped into (i) uncoated, (ii) with a frasscoat ratio of 1:4.2, and (iii) with a frasscoat ratio of 1:6.5 and underwent the germination procedure as described in Example 6 and were sown on July 15 and 16. Many seeds did not germinate; hence data from July 15 and 16 are combined.

A total of 7/72 uncoated seedlings, 5/72 coated 1:6.5 seedlings and 5/72 coated 1:4.2 seedlings germinated after day 10.

Damage scoring (as described in Example 7) was carried out on day 17 and day 24 and the significance of the result tested using an ANOVA test. No significant difference between percentage damage score of the coated seeds compared to uncoated seeds was observed after 17 days. As seen in FIG. 7, on day 24, the damage score for coated seeds (particularly those with a frasscoat ratio of 1:6.5) was less (ANOVA test, F=0.136). There was a remarkable percentage area damage difference in coated and uncoated seedlings.

On observation one uncoated seedling has 28 flea beetles and a larger percentage area damage caused by flea beetles. The coated seedling nearby had significantly less damage area.

### Example 13: Biostimulant Test for Acacia OSR Seeds at Different Frasscoat Ratios (Cotyledon Diameter)

Trays of uncoated and 1:6.5 frasscoat ratio coated seed, and 1:4.2 frasscoat ratio coated acacia OSR seedlings (G17) underwent the germination procedure as described in Example 6 and were sown on July 29.

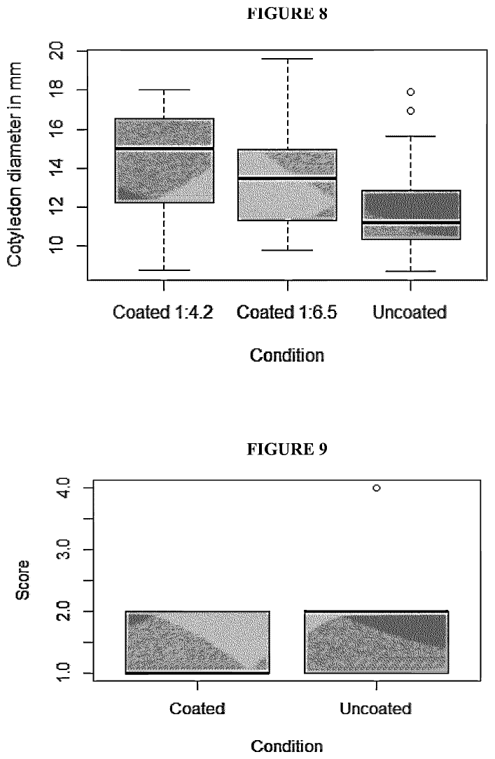

Cotyledon diameter was measured on day 15 as described in Example 8 and is shown in FIG. 8. Post hoc pairwise test suggests a significant difference in cotyledon diameter between uncoated seedlings and seedlings with frasscoat ratio 1:6.5 (p=0.0113), with coated seeds having an increased diameter. Similarly, there is a significant difference in cotyledon diameter between uncoated seedlings and seedlings with frasscoat ratio 1:4.2 (p=0.00021), with coated seedlings having increased diameter. Results suggest that the frass coat shows promising biostimulant effect on OSR seeds, and stimulates OSR growth, increasing their leaf area.

### Example 14: Pest-Repellent Test for Nikita OSR Seeds

Trays of uncoated and coated Nikita OSR seeds (G22) underwent the germination procedure as described in Example 6 and were sown on September 3, wherein the coated seeds had a frasscoat ratio of 1:6. On day 14 after sowing, the G22 seedlings were taken to a field trial center and replanted as described in Example 7. On day 17, the damage score of the seeds was assessed as described in Example 7. Results are shown in FIG. 9 (two-sample one-tailed t-test, p=0.184).

### Example 15: Biostimulant Test for DK Exception OSR Seeds

Trays of uncoated and coated DK exception OSR seedlings (G28) underwent the germination procedure as described in Example 6 and were sown on September 14, wherein the coated seeds had a frasscoat ratio of 1:6.

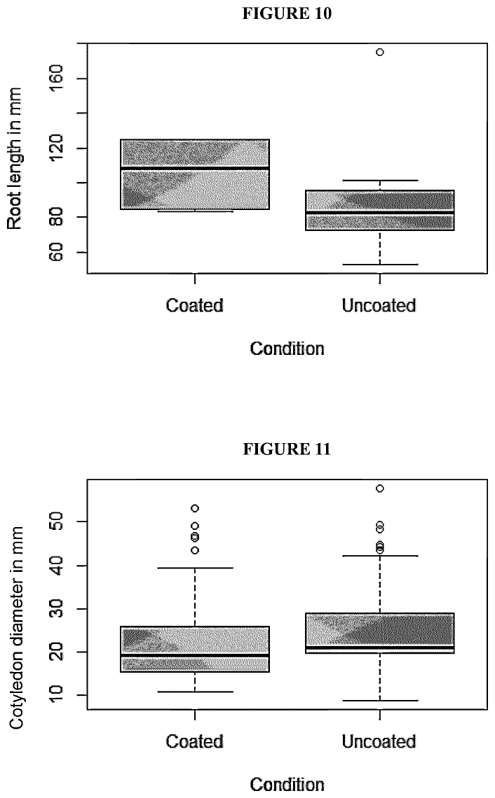

The root length was measured on day 20, as described in Example 8. Results are shown in FIG. 10 (two-sample one-tailed t-test, p=0.7697).

The cotyledon diameter of coated and uncoated seeds was also measured on day 20, as described in Example 8. Results are shown in FIG. 11 (two-sample one-tailed t-test, p=01745).

### Example 16: Pest-Repellant and Biostimulant Test for Campus OSR Seeds

Trays of uncoated and coated seed, Campus OSR seeds (G29) underwent the germination procedure as described in Example 6 and were sown on September 15, wherein the coated seeds had a frasscoat ratio of 1:6. On day 5 after sowing, the G29 seedlings were taken to a field trial center and replanted as described in Example 7.

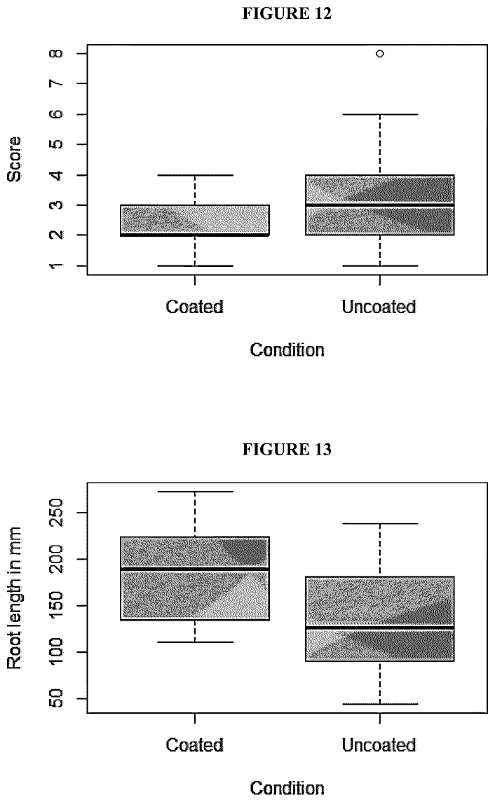

Damage scoring (as described in Example 7) was carried out on day 26. As shown in FIG. 12, the % damage score of the G29 coated seeds was significantly less than the G29 uncoated seeds (two-sample one-tailed t-test, p=0.000532).

Root length of G29 coated and uncoated seeds was also measured, on day 34 as described in Example 8. Results are shown in FIG. 13 (two-sample one-tailed t-test, p=0.9985).

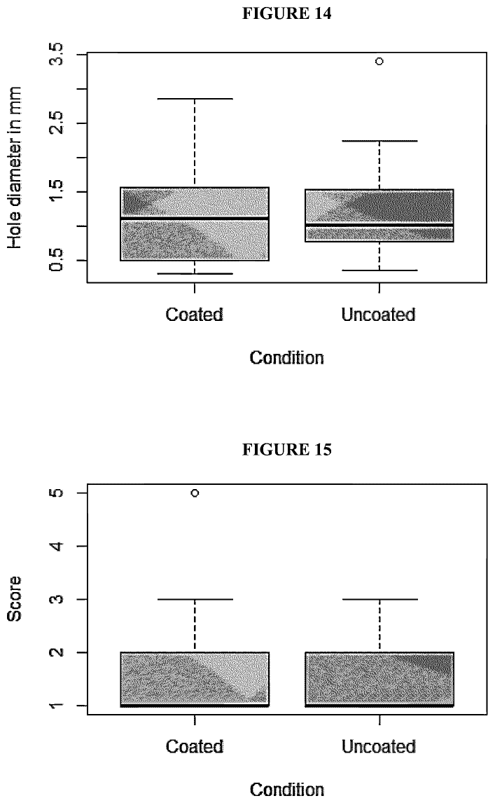

Hole diameter was also measured according to Example 8 on day 34. Results are shown in FIG. 14 (two-sample one-tailed t-test, p=0.4005).

### Example 17: Further Pest-Repellant and Biostimulant Test for DK Exception Seeds

Trays of uncoated and coated seed DK exception OSR seedlings (G30) underwent the germination procedure as described in Example 6 and were sown on September 15, wherein the coated seeds had a frasscoat ratio of 1:6. On day 5 after sowing, the G30 seedlings were taken to a field trial center and replanted as described in Example 7.

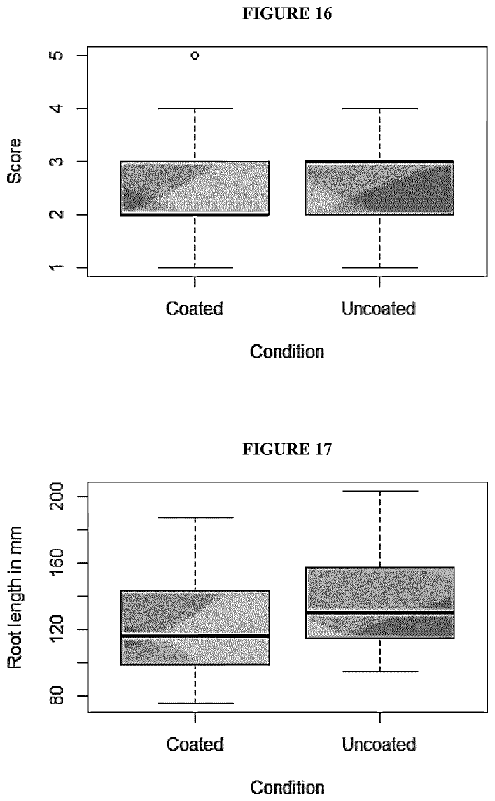

On day 12 and day 26, damage score of the seeds was assessed as described in Example 7. Results are shown in FIG. 15 (two-sample one-tailed t-test, p=0.5614). FIG. 16 shows the results of damage score measurements taken on day 26 (two-sample one-tailed t-test, p=0.08184).

Root length of G30 coated and uncoated seeds was also measured, on day 48 as described in Example 8. As shown in FIG. 17, the root length of the G30 coated seeds were significantly smaller than G30 uncoated seeds according to the test (two-sample one-tailed t-test, p=0.9985).

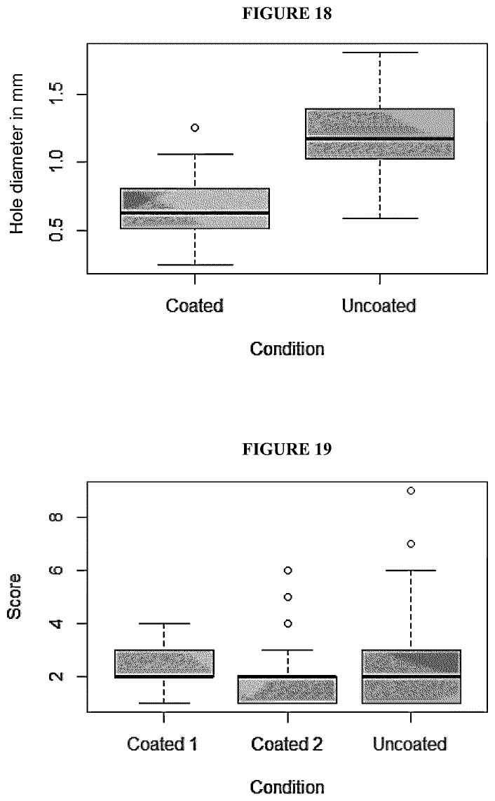

Hole diameter was also measured according to Example 8 on day 48. As shown in FIG. 18 there was a significant difference between the hole diameter of the coated and uncoated groups on day 48 (two-sample one-tailed t-test, p=0.02288).

### Example 18: Pest-Repellant and Biostimulant Test for Aurelia OSR Seeds with Different Frasscoat Ratios

Trays of uncoated (UC) and 1:4.3 frasscoat ratio coated seed (C1), and 1:6.5 frasscoat ratio coated (C2) Aurelia OSR seedlings (G31) underwent the germination procedure as described in Example 6 and were sown on September 17. On day 10 after sowing, the G31 seedlings were taken to a field trial center and replanted as described in Example 7.

On day 24, the damage score of the seeds was assessed as described in Example 7. Results are shown in FIG. 19 (three-sample Kruskal-Wallis rank sum test, p=0.93 [UC-C1], p=0.12 [UC-C2], p=0.12 [C1-C2]).

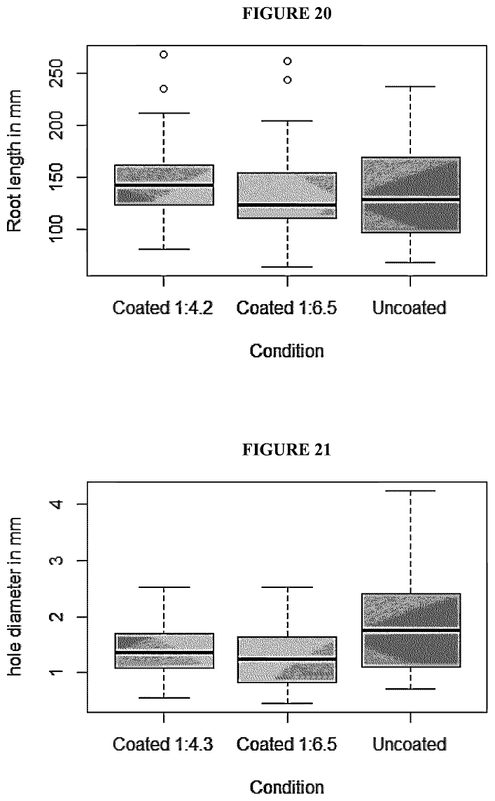

Root length of G31 seeds was also measured on day 31 as described in Example 8. Results are shown in FIG. 20 (three-sample one-tailed Kruskal-Wallis rank sum test, p=0.93 [UC-C1], p=0.19 [UC-C2], p=0.19 [C1-C2]).

Hole diameter was also measured according to Example 8 on day 31. Results are shown in FIG. 21. Interestingly, the coated batch with the less amount of coating did show significantly smaller holes when compared with the uncoated OSR. This can be used to deduce the optimal amount of coating required to show the greatest repellent effect (three-sample one-tailed Kruskal-Wallis rank sum test, p=0.044 [UC-C1], p=0.208 [UC-C2], p=0.503 [C1-C2]).

What is claimed is:

1. A coated seed comprising:
a seed and a coating on said seed wherein said coating comprises a bioadhesive and one or more bioactive agents;
wherein the bioadhesive comprises one or more protein containing biomaterials, an inorganic filler, and a defoamer; and
wherein the one or more bioactive agents are selected from a biorepellent, pesticide, fertilizer, or bactericide.

2. The coated seed of claim 1 wherein the one or more bioactive agents comprise frass.

3. The coated seed of claim 1 or 2 wherein the one or more protein-containing biomaterials are selected from distiller's grain, brewer's spent grain and algal materials.

4. The coated seed of any one of claims 1 to 3 wherein the inorganic filler comprises one or more calcium-containing materials, preferably one or more of calcium oxide, calcium hydroxide, calcium carbonate, calcium chloride, and calcium sulfate, more preferably one or more of calcium oxide and calcium sulfate.

5. The coated seed of any one of claims 1 to 4 wherein the defoamer comprises one or more of mineral oil, silicon oil, vegetable oil, or white oil.

6. The coated seed of any one of claims 1 to 5 wherein the viscosity of the bioadhesive is from 100 mPa·s to 10,000 mPa·s.

7. The coated seed of any one of claims 1 to 6 wherein the one or more bioactive agents comprise chitin.

8. The coated seed of any one of claims 1 to 7 wherein the bioactive agent has an average particle size of from 10 microns to 500 microns, preferably wherein the bioactive agent has an average particle size of from 10 microns to 200 microns, more preferably wherein the bioactive agent has an average particle size of from 100 microns to 200 microns.

9. The coated seed of any one of claims 1 to 8 wherein the seed is a Brassica seed, preferably wherein the seed is an oil seed rape seed.

10. A process for producing a coated seed according to any one of claims 1 to 9 comprising applying to a seed (a) one or more bioactive agents as defined in claim 1, 2, 7, or 8 and (b) a bioadhesive as defined in any one of claims 1 and 3 to 6 and forming a coating on the seed.

11. The process of claim 10 comprising mixing the bioactive agent(s) and the bioadhesive to produce a coating resin and applying the resin to a seed to form a coating thereon.

12. The process of claim 10 comprising:
a. coating a seed with the bioadhesive; and
b. mixing the bioadhesive coated seed with one or more bioactive agents.

13. The process of any one of claims 10 to 12 wherein the seed is a Brassica seed, preferably wherein the seed is an oil seed rape seed.

14. The process according to any one of claims 10 to 13 wherein the bioactive agent is prepared by milling to provide an average particle size of from 10 microns to 500 microns, preferably from 10 microns to 200 microns, more preferably from 100 microns to 200 microns.

15. A coating resin comprising one or more bioactive agents and a bioadhesive wherein the one or more bioactive agents are as defined in any one of claims 1, 2, 7, and 8 and the bioadhesive is as defined in any one of claims 1 and 3 to 6.

16. A kit comprising separately one or more bioactive agents as defined in any one of claims 1, 2, 7, and 8 and a bioadhesive as defined in any one of claims 1 and 3 to 6.
